(19) United States
(12) Patent Application Publication
(10) Pub. No.: US 2002/0102528 A1
(43) Pub. Date: Aug. 1, 2002

(54) Display device and method for marketing automobile fluid replacement services

(76) Inventor: Robert Moore, West Palm Beach, FL (US)

Correspondence Address: Daniel P. Devers, SHOOK, HARDY & BACON L.L.P., 1200 Main Street, Kansas City, MO, 64105-2118, US

(21) Appl. No.: 09/770,822

(22) Filed: Jan. 26, 2001

(51) Int. Cl. G09B 25/00

(52) U.S. Cl. 434/381

(57) ABSTRACT

A device for displaying actual and new fluids is provided. In its preferred embodiment, the device has a lower plate and upper plate separated by clear glass tubes. Two glass containers are placed on each side of the respective plates. On each side of the device, the lower plate includes indicia to indicate the fluid type held in the glass tubes on that side and the upper plate indicates which container contains the actual fluid and which contains the new fluid.

### CROSS-REFERENCE TO RELATED APPLICATIONS

“Not Applicable”

### STATEMENT REGARDING FEDERALLY SPONSORED RESEARCH AND DEVELOPMENT

“Not Applicable”

### BACKGROUND OF THE INVENTION

This invention relates to the field of automobile repair services and, more particularly, to a device for displaying automobile fluids and marketing automobile fluid replacement services.

The automobile service industry is a significant component of our domestic economy. Virtually every consumer who owns and drives a vehicle requires the assistance of an automobile service technician to repair their vehicle or to service the vehicle to ensure its long term operation.

One of the most significant components of ensuring long term performance of an automobile is to maintain clean and properly functioning fluids within the various systems of the automobile. Automobiles require fluids for a variety of purposes such as to maintain low friction environments within certain systems, to cool engine components and to serve as a hydraulic media. For instance, motor oil is used to lubricate the combustion components of the vehicle. Also, a coolant is circulated throughout the components of the engine to maintain a low temperature. Other important fluids such as power steering fluid, transmission fluid and transmission differential fluid are used in various systems of the automobile.

Each fluid must be regularly inspected to determine if the inherit qualities of the fluid have been compromised as a result of the heat and frictional environment in which the fluid operates. If the fluid shows signs of contamination or degradation, the fluid must be replaced. Failure to replace a fluid at the appropriate time can result in significant damage to the system of the vehicle requiring the fluid, and adversely affect the ability of the vehicle to function properly.

Historically, it has difficult to determine when each of the automobile fluids requires replacement. Most automobile manufacturers provide mileage guidelines at which certain fluids should be replaced. However, these guidelines do not account for the actual condition of the fluid at issue. The actual condition may vary from one automobile to another based on the operator's driving habits, weather conditions, the quality of the fluid and a number of other factors. Consequently, it is oftentimes necessary to determine if the actual fluids need replacement prior to the mileage intervals suggested by the guidelines.

The actual condition of many automobile fluids may be made by visual inspection. However, it is difficult to make this inspection since many of the component fluids of the automobile are not readily visible for inspection. Particularly, several fluids are circulated deep within the internal components of the engine. Certain engine components have dipsticks (or rods) extending into the fluid reservoir within the engine that can be withdrawn to ascertain the fluid level. However, dipsticks are inherently inaccurate and do not allow for an adequate visual inspection of the color and consistency of the fluid. Moreover, many vehicles do not have dipsticks for accessing the fluids necessary for the vehicle to perform properly.

In addition, many vehicle owners are reluctant to replace the fluids without compelling evidence indicating the need for the change. The costs associated with changing fluids can be substantial and, unless the vehicle is malfunctioning in a significant manner, many consumers cannot justify spending the money to have their vehicle engine fluids changed. Even after receiving warnings as to the potential damage of operating the vehicle with a fluid in substandard condition, many consumers simply are not convinced of the need for replacement service.

### BRIEF SUMMARY OF THE INVENTION

It is an object of the present invention to provide a display device to allow visual comparison of actual automobile fluid samples of various types with new, unused samples of the same types so the consumer can appreciate the need for replacement of the actual fluids.

In accordance with this and other objects evident from the following description of a preferred embodiment of the invention, a device for displaying actual and new fluids is provided. In its preferred embodiment, the device has a lower plate and upper plate separated by clear glass containers. Two glass containers are placed on each side of the respective plates. On each side of the device, the one plate includes indicia to indicate the fluid type held in the containers on that side and the one plate indicates which container contains the actual fluid and which contains the new fluid.

### BRIEF DESCRIPTION OF THE DRAWINGS

The preferred embodiment of the present invention, and the prior art, are described in detail below with reference to the attached drawings, wherein:

FIG. 1 is a perspective view of a prior art plate for comparing fluid samples;

FIG. 2 is a perspective view of a display device of the present invention, taken from above, with parts being broken away to illustrate details of the construction of the lower plate;

FIG. 3 is front elevational view of the display device of FIG. 2; and

FIG. 4 is a perspective view of the display device of FIG. 2 illustrating one container partially removed from the device and with the threaded cap shown in an exploded manner.

### DETAILED DESCRIPTION OF THE INVENTION

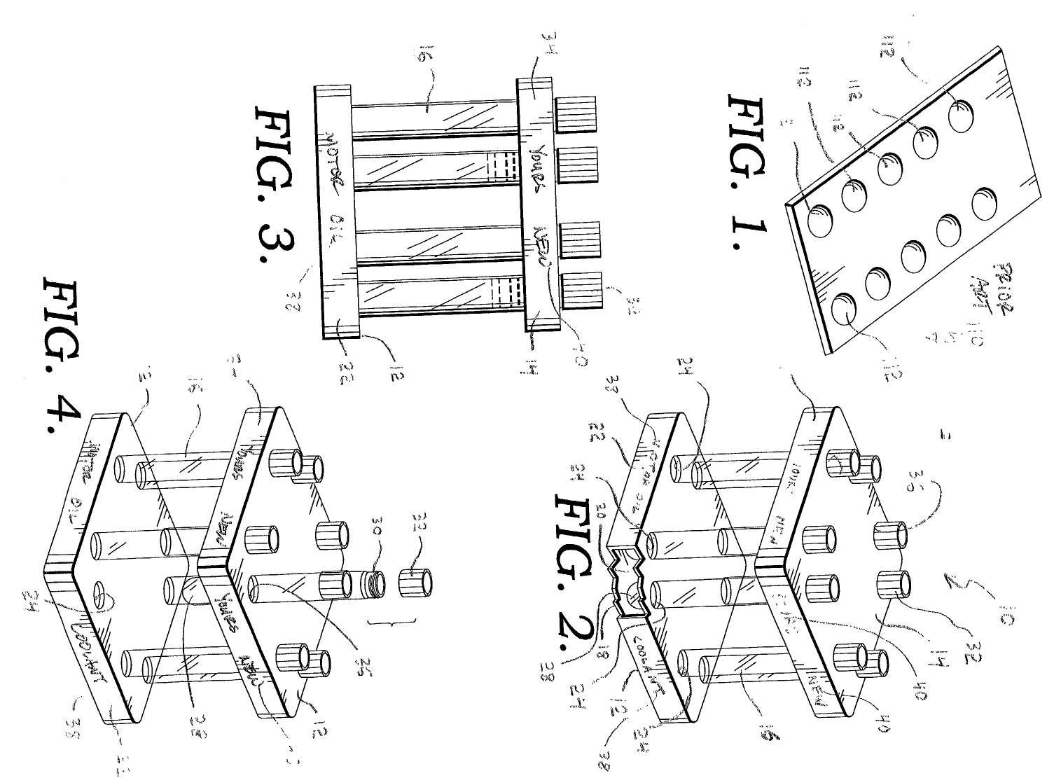

As shown in FIGS. 2-4, a display device in accordance with the preferred embodiment of the present invention is shown. In FIG. 1, a device previously used to compare automobile fluids is designated by the numeral 110.

Prior to the advent of the present invention, some automobile service technicians attempted to compare automobile fluids for the purposes of marketing replacement fluids and replacement services. The technician would take a sample of one or more fluids and apply the samples to a sheet of paper. This was inherently inaccurate since the fluid would bleed into the paper and alter its actual appearance. Moreover, as the paper became saturated, fluid would leak to the surrounding environment. Additionally, this process was capable of manipulation on the part of the technician to sell unneeded fluid services to unwary consumers.

To alleviate some of these problems, certain automobile service technicians began using devices such as the tray illustrated in FIG. 1. As shown in FIG. 1, the tray 110 defines a number of indentations 112 within which samples of automobile fluid may be placed. The semi-hemispherical indentations 112 are arranged in pairs so that a sample of automobile fluid taken from the automobile may be placed within one indention and compared with a sample of new automobile fluid of the same type placed within the opposing indention. However, fluid oftentimes escaped from the indentations in the plate onto the surrounding environment if too much fluid was placed in any one indention. Likewise, fluid would escape the plate if the plate was not held in a generally horizontal orientation-an orientation that is particularly difficult to maintain as successive fluid samples are being added to the tray. When fluid escaped from one indentation, the fluid oftentimes would move into a different indentation and contaminate the sample in that indentation. Also, with each successive automobile, the technician had to replenish the new fluid constituent lost from the tray when the actual fluid samples from the previous vehicle were being cleaned from the tray. Finally, the color of the tray underlying each sample altered the appearance of the samples and limited the effectiveness of the comparison.

As shown in FIG. 2, a display device constructed in accordance with the preferred embodiment of the present invention is designated generally by reference numeral 10. Display device 10 broadly includes a lower plate 12, an upper plate 14 and a plurality of containers 16 disposed between the plates.

Lower plate 12 is preferably constructed from a pair of opposing rectangular surfaces 18 and 20, and a continuous sidewall 22 extending therebetween. A pair of circular openings 24 are located along each side of upper surface 18. The openings 24 are sized to receive containers 16. Each of the eight containers 16 is placed through the respective openings and into the space between the upper and lower surfaces. One container on each side of the device 10 is fixedly secured to the lower plate 12. The connection is achieved by frictional fitting, glueing or otherwise maintaining a fixed relationship between the container and the lower plate 12.

The containers 16 are preferably made of clear cylindrical glass test tubes. As shown in FIG. 4, each test tube has a rounded lower end 28 and a threaded upper end 30 adapted to receive a correspondingly threaded cap 32. It is to be understood that other configurations of containers can be employed in connection with the present invention. For example, the containers 16 can take the form of individual jars, prism-shaped devices or capillaries. The containers should be relatively transparent so that a consumer can clearly ascertain the visual condition of the fluid being observed. Slightly translucent and colored-shaped containers can be used for this purpose.

Upper plate 14 is preferably the same shape and size as the lower plate 12, and presents a continuous sidewall 34 between the upper and lower surfaces of the plate. Openings 36 are disposed in pairs along each side of the upper plate 14 in a pattern identical to the lower plate. However, on the upper plate 14, the openings extend completely through the plate so that the threaded portion of the upper ends 30 of the containers 16 extend beyond the upper surface of the plate 14. Those containers that are fixedly secured to the lower plate 12 are also fixedly secured to the upper plate 14 to maintain the upper and lower plates at a distance from one another.

Preferably, the container of each pair that is fixedly secured to the lower plate 12 and upper plate 14 is used to hold the new automobile fluids. With reference to FIG. 4, the container of each pair adapted to display an actual sample for the consumer's automobile is preferably removable with respect to the upper and lower plates. Specifically, the containers containing the actual samples are slidable with respect to the openings 24 and 36 in the lower and upper plates, respectively. With reference to FIG. 2, when the display device is generally horizontal, the lower ends 28 of the unsecured containers rest against the lower surface 18. To remove the container, the container is pulled away from the upper and lower plates until the lower end 28 of the container is cleared from the upper plate.

Indicia are placed on the sidewalls of the upper and lower plates to indicate the contents of each container. Specifically, the sidewalls contain indicia indicating the type of fluid to be compared and the associated source of fluid for each container. In the preferred embodiment, the lower plate 12 has indicia 38 to indicate the type of fluid to be compared. As shown in FIG. 2, the indicia for one side indicates that motor oil is to be placed in the containers on that side and the indicia for another side indicates coolant is to be placed in the containers. The sidewall 34 of upper plate 14 has a pair of indicia 40 for each side of the display device, each indicia associated with one of the tubes on that particular side. The indicia “yours” indicates that the source of the fluid within the container is the consumer's own vehicle, and the indicia “new” indicates that the source of the fluid is a new, unused fluid supply.

Preferably, the indicia are pre-printed and adhered to the appropriate plate. However, the indicia may be painted, engraved or otherwise displayed on the plates. Also, the form of the indicia may vary to include icons, abbreviations or other indicia that indicate the contents of each tube. Moreover, the indicia may appear on the lower sidewall 22, the upper sidewall 34, or both. In fact, the characteristics of the containers may vary to indicate the contents within the tubes. For example, squared containers could be used to indicate new fluid samples and round containers used to indicate actual fluid samples.

In the preferred embodiment, the device can compare four different types of fluid sampled from an automobile engine-motor oil, coolant, steering fluid and transmission fluid. It is to be understood, that the device of the present invention can be configured to compare any number of sets of vehicle fluids by adding or subtracting sides to the device. For example, if three fluids are to be compared, the device 10 can be configured in a triangular shape. Similarly, for comparing five different vehicle fluids, the device can be configured in a pentagonal shape. This election of shape of the device should correspond to the number of fluids to be compared and is within the ordinary understanding of an automobile service technician.

In use, after the consumer's vehicle arrives at the service facility, the service technician carefully fills the four tubes aligned with the indicia indicating “yours” with the respective vehicle fluids. For example, on the side of the device indicating coolant, the technician would remove the container 16 aligned with the indicia “yours” and fill that container with a sample of the coolant from the vehicle. The technician then will do the same with respect to the transmission fluid, motor oil and steering fluid for the vehicle.

When the service technician is completed with this initial task, the device 10 will have a sample of each of the four fluids from the consumer's vehicle. The technician then can fill the respective containers 16 aligned with the indicia “new” with new fluids for that specific type of system. It should be understood that the technician can prefill the containers lined with “new” prior to obtaining fluid samples from the consumer vehicle. It is a matter of the technician's choice as to whether the “new” containers are filled prior to obtaining the samples or subsequent to obtaining the samples. It should also be understood that once the “new” containers are filled with new unused fluid, the containers need not be filled again until such time as the visual characteristics of the fluids require the fluid change. This should be a relatively infrequent exercise.

When the technician has completed these tasks, the device is then presented to the consumer to observe the visual characteristics of the consumer's vehicle fluids with respect to new fluids and to decide whether each particular fluid should be replaced. For example, the technician or customer can turn device 10 to the side indicating the motor oil fluid system. The technician and consumer can visually compare the different visual characteristics of the new motor oil against the consumer's actual motor oil. If the visual characteristics of the fluids are distinct and indicative of contamination of the motor oil of the consumer's vehicle, the technician can recommend the specific service to the consumer, whether a simple fluid change or whether additional services such as a system flush is needed. Using the device of the present invention, the consumer is given objective evidence as to whether additional services on his or her vehicle is needed before the consumer exits the service facility. The determination of whether additional services should be performed can be made by the consumer quickly at the time of the initial consultation with the customer service technician.

Since the fluids are completely enclosed within the containers, the problems of contamination and spilling are avoided. Moreover, the containers do not skew the visual appearance of the fluid samples like the prior attempts. The new samples need not be replaced with each successive automobile, and the containers for the new sample may be removed from the plates of the display device and filled proximate the automobile. Moreover, since containers of one fluid type are disposed on each side, the display device allows the consumer to focus on the comparative state of each system one at a time to make an informed decision to replace the fluid or not.

As can be readily seen, the device of the present invention allows for the consumer to make an educated decision as to whether certain vehicle services are needed. Consumers with little or no mechanical experience or knowledge can easily determine for themselves whether services are required. While not all vehicle fluids indicate a need for change simply by visual comparison, the visual condition of most fluids is instructive as to the condition of the fluid and, more importantly, of the system with which the fluid is to be used. In some instances, the visual comparison of the fluids may indicate not only a fluid change is needed but also signal that significant repairs should be performed. This is both helpful to the technician and to the consumer.

By using the device of the present invention, the likelihood of proper vehicle maintenance is increased. Similarly, while not a fundamental purpose of the present invention, sales of fluid change and flush services by a service facility will increase as a result of the educational purpose fulfilled by the present invention to the consumer about the need to maintain and change vehicle fluids. The result is a situation wherein the service facility benefits from increased sales of the its services and the consumer benefits by being provided with information necessary to determine whether vehicle fluids are in need of replacement or vehicle components are in need of service.

Although the invention has been described with reference to the preferred embodiment illustrated in the attached drawing figures, it is notes that substitutions may be made and equivalents employed herein without departing form the scope of the invention as recited in the claims.

1. A device for displaying automobile fluids to a consumer, said device comprising:
a first plate;
a first pair of transparent fluid containers, the containers of the first pair secured to the first plate and extending therefrom in proximity to one another, the first container of said first pair adapted to contain an unused sample of a first type of automobile fluid and the second container of the first pair adapted to contain an actual sample of the first type of automobile fluid,
whereby a visual comparison of the unused sample and the actual sample may be made to determine the condition of the actual sample.

2. A display device as recited in claim 1, further comprising a second plate, the first pair of containers secured to the first and second plates.

3. A display device as recited in claim 2, wherein the first and second plates have a plurality of corresponding sides and wherein the first pair of containers are secured to the plates at one of the corresponding sides.

4. A display device as recited in claim 3, wherein one of the first and second plates includes an indicia corresponding to the first type of fluid, the type indicia disposed on the one of the corresponding sides.

5. A display device as recited in claim 4, wherein the other of the first and second plates includes an indicia to differentiate the first container from the second container of the first pair.

6. A display device as recited in claim 3, wherein the second container of the first pair is removably secured to the plates so that the actual sample may be placed within the second container when the container is removed from the plates.

7. A display device as recited in claim 3, further comprising at least one other pair of containers, the other pair secured to a second of the corresponding sides of the plates and adapted to contain samples of a second type of automobile fluid.

8. A display device as recited in claim 7, further comprising an indicia corresponding to the second type of automobile fluid, the second type indicia disposed on one of the plates at the second corresponding sides.

9. A display device as recited in claim 8, further comprising an indicia to differentiate the first container from the second container of the second pair.

10. A display device as recited in claim 9, further comprising a third pair of containers, the third pair secured to a third of the corresponding sides of the plates and adapted to contain samples of a third type of automobile fluid.

11. A display device as recited in claim 10, further comprising a fourth pair of containers, the fourth pair secured to a fourth of the corresponding sides of the plates and adapted to contain samples of a fourth type of automobile fluid.

12. A display device as recited in claim 11, wherein the types of automobile fluids are motor oil, coolant, transmission fluid and brake fluid.
